(19) United States
(12) Patent Application Publication
(10) Pub. No.: US 2019/0208771 A1
(43) Pub. Date: Jul. 11, 2019

(54) AGROCHEMICAL GEL COMPOSITION

(71) Applicant: Monsanto Technology LLC, St. Louis, MO (US)

(72) Inventors: Eve De Maesschalck, Louvain-la-Neuve (BE); Michael P. Myers, Brecksville, OH (US); Daniel R. Wright, St. Louis, MO (US)

(73) Assignee: Monsanto Technology LLC, St. Louis, MO (US)

(21) Appl. No.: 16/323,739

(22) PCT Filed: Aug. 9, 2017
(86) PCT No.: PCT/US2017/046128

§ 371 Date: Feb. 6, 2019

Related U.S. Application Data
(60) Provisional application No. 62/372,671, filed on Aug. 9, 2016.

(51) Int. Cl. A01N 25/04; A01N 25/10; A01N 57/20; A01N 37/02

(52) U.S. Cl. CPC A01N 25/04; A01N 37/02; A01N 57/20; A01N 25/10

(57) ABSTRACT

Improved aqueous herbicidal gel compositions comprising at least one water-soluble herbicide and a gel forming agent are provided. The gel compositions are particularly useful in increasing the loading of the water-soluble agrochemical salt, maximizing agrochemical uptake and/or translocation into treated plants and minimizing agrochemical loss to the environment. Methods for confined application of the gel compositions to control the growth of unwanted plants are also disclosed.

### FIELD OF INVENTION

The present invention generally relates to an aqueous gel composition comprising at least one water-soluble agrochemical salt that is particularly suited for increasing the loading of the water-soluble agrochemical salt, maximizing agrochemical uptake and/or translocation into treated plants and minimizing agrochemical loss to the environment, and to methods of confined application of the agrochemical.

### BACKGROUND OF INVENTION

Agrochemicals, such as herbicides, are typically delivered to plant foliage by an over-the-canopy broadcast application of dilute aqueous tank mixes or application mixture formulations. Problematically, a significant portion of the broadcast application either misses the target plant foliage or drips off the foliage after application. Further, prior art tank mixes and application mixture formulations dry quickly after foliage application thereby providing only a limited time period for pesticidal transfer into the plant. This problem is especially prevalent in the application of agrochemicals to so called woody weeds, such as tree trunks, tree stumps, cut stems, and bushes. Consequently, inefficient pesticidal use and concomitant environmental contamination occur. Less than about 10% of the applied pesticide may be actually taken up into the target plant, with the remainder constituting pesticide waste that remains in the field.

Thus, there is a need for agrochemical compositions and methods for application to plants thereof that provide enhanced agrochemical retention on plant foliage, tree trunks, tree stumps, cut stems, and bushes, increased efficiency in transfer of agrochemicals to the plants, and minimized agrochemical loss to the environment. Such agrochemical compositions have been discussed; particularly agrochemical gel formulations which are readily retained on the application site and resist drying for longer periods of time. See, for example, International Application Publication No. WO 2011/113061.

For the application of an agrochemical composition to woody weeds, tree trunks, tree stumps, cut stems, and bushes, a high content of the agrochemical component may be needed in order to achieve the desired phytotoxic impact and amount of agrochemical taken up into the target plant. Problematically, however, when formulating such high-load compositions as an aqueous gel, it has been observed that as the agrochemical salt content increases (e.g., in excess of about 5 percent by weight on an acid equivalent basis), conventional gel forming agents tend to collapse, rendering formulation difficult and undermining the desired rheological properties of the composition. As a result, the performance of high-load aqueous agrochemical gel compositions is hampered as a result of the product not being sufficiently retained on the target plant to allow for efficient transfer of agrochemical to the target plant.

Thus, there remains a need for aqueous agrochemical gel compositions that permit the incorporation of higher concentrations of agrochemical salts while still maintaining the desirable rheological properties of the gel composition.

### SUMMARY OF INVENTION

Briefly, therefore, the present invention is directed to an aqueous agrochemical gel composition comprising from about 3 to about 20 percent by weight (wt %) on an acid equivalent basis of a water-soluble agrochemical salt component; from about 0.1 to about 5 percent by weight (wt %) of a polymeric gel forming agent component comprising an interpolymer of a) at least one olefinically unsaturated carboxylic acid or anhydride containing at least one activated carbon-to-carbon olefinic double bond and at least one carboxyl group, in an amount of more than about 15% by weight based upon the weight of interpolymer, and b) at least one steric stabilizer having at least one hydrophilic moiety and at least one hydrophobic moiety, selected from the group consisting of linear block copolymeric steric stabilizers, having a hydrophobic moiety having a length of more than about 50 Angstroms, random copolymeric comb steric stabilizers, and mixtures thereof; and from about 70 to about 94 percent by weight (wt %) water.

The present invention is still further directed to a method of confined application of a water-soluble herbicide salt to unwanted plants, the method comprising applying the gel composition to the unwanted plant.

Other objects and features will be in part apparent and in part pointed out hereinafter.

### DESCRIPTION OF THE PREFERRED EMBODIMENTS

In accordance with the present invention, aqueous ready-to-use (RTU) agrochemical gel compositions comprising at least one water-soluble agrochemical salt and at least one polymeric gel forming agent for direct application to plants are provided. By selection of a polymeric gel forming agent as described herein, the aqueous agrochemical gel compositions exhibit and retain desirable rheological properties at elevated agrochemical salt concentrations. The rheological properties allow selective and directed application of the compositions of the present invention to small areas, such as individual plants, cut stems or stumps for extended periods of contact time, and therefore are particularly useful for lawns, gardens, and other areas where unwanted plants are located among highly concentrated desirable vegetation. The increased loading of agrochemical salt present in the gel makes the compositions particularly suited for application to unwanted woody weeds, tree trunks, tree stumps, cut stems, and bushes where a high content of the agrochemical salt component can provide the desired phytotoxic impact and increase the amount of agrochemical salt taken up into the target plant. The improved retention and resistance to drying provided by the gel compositions of the present invention provide more efficient uptake of the agrochemical salt into the target plants and/or enhanced translocation within the plants to more effectively kill the plants.

The aqueous gel compositions of the present invention are preferably pseudoplastic, elastic and possess a relatively high stationary viscosity. The high stationary viscosity of the gel compositions of the instant invention facilitates the tendency of the gels to be retained on the plant material. The pseudoplastic nature of the gel compositions provides for low viscosity under elevated stress or shear conditions thereby enabling ease of application, for example, during pumping, spraying, brushing, or roll-on application. The high stationary viscosity of the gels then returns under low or no stress (shear) conditions, such as after the compositions are applied to plant foliage. The elastic nature of the gels enhances retention on plant material. Embodiments of the present invention that do not comprise one or more water-insoluble agrochemicals are typically single phase or microemulsions. Embodiments of the present invention comprising one or more water-insoluble agrochemicals are typically multi-phase compositions including suspensions and/or emulsions.

For purposes of the present invention, agrochemicals include herbicides, plant growth regulators, acaricides, insecticides, virucides, algicides, bactericides, fungicides, nematicides, herbicide safeners, plant activators or synergists, racemic mixtures and resolved isomers thereof, and mixtures and combinations thereof. In some embodiments, the agrochemical is a pesticide such as a herbicide, insecticide, algicide, bactericide, fungicide or nematicide. Suitable water-soluble herbicides salts are selected from acetyl CoA carboxylase (ACCase) inhibitors, acetolactate synthase (ALS) or acetohydroxy acid synthase (AHAS) inhibitors, photosystem II inhibitors, photosystem I inhibitors, protoporphyrinogen oxidase (PPG or Protox) inhibitors, carotenoid biosynthesis inhibitors, enolpyruvyl shikimate-3-phosphate (EPSP) synthase inhibitors, glutamine synthetase inhibitors, dihydropteroate synthetase inhibitors, mitosis inhibitors, synthetic auxins, auxin transport inhibitors, nucleic acid inhibitors, certain unclassified herbicides, and mixtures thereof.

Examples of suitable water-soluble herbicides include, without restriction, agriculturally acceptable salts of 2,4-D, 2,4-DB, acifluorfen, aminopyralid, amitrole, asulam, azimsulfuron, beflubutamide, benazolin, bentazon, bispyribac-sodium, bromacil, carbetamide, carfentrazone-ethyl, chlorimuron-ethyl, chlorsulfuron, cinosulfuron, clopyralid, dicamba, dichlorprop, diclofop, diclopyr, difenzoquat, dimethenamid, dimethipin, diquat, DSMA, endothall, ethoxysulfuron, floramsulfuron, florasulam, flucarbazone-sodium, flumetsulam, fluroxypyr, fosamine, glyphosate, glufosinate, glufosinate-P, halosulfuron-methyl, hexazinone, imazamethabenz-m, imazamox, imazapic, imazapyr, imazaquin, imazethapyr, iodosulfuron, MCPA, MCPB, mecoprop, mecoprop-P, MSMA, naptalam, nicosulfuron, paraquat, water-soluble, agronomically acceptable salts of fatty acids predominantly comprising C₈ to C₁₂ saturated, straight or branched chain fatty acids (e.g., water-soluble, agronomically acceptable salts of pelargonic acid), penoxsulam, picloram, primisulfuron-methyl, propoxycarbazone-sodium, prosulfuron, pyrithiobac-sodium, sethoxydim, sulfentrazone, sulfosulfuron, tebuthiuron, tepraloxydim, thifensulfuron-methyl, tralkoxydim, triasulfuron, tribenuron-methyl, triclopyr, trifloxysulfuron and triflusulfuron-methyl, and mixtures and combinations thereof. As used herein, where an herbicide or other agrochemical is referred to by name, such as glyphosate or glufosinate, it is understood that agriculturally acceptable salts of the agrochemical are included.

For the purposes of the present invention, “agriculturally acceptable salts” are generally defined as salts that provide desired solubility, bioefficacy, toxicity and environmental safety characteristics for the intended use. Typical cations for the herbicide salts of the present invention include, without restriction, sodium, potassium, monoethanolamine (MEA), dimethylamine (DMA), isopropylamine (IPA), trimethylsulfonium (TMS) diethylammonium (DEA), triethanolamine (TEA), diglycolamine (DGA), lithium, and ammonium. Typical anions for the formation of herbicide salts include, without restriction, chlorine, bromine, fluorine and acetate.

In some embodiments of the present invention, the water-soluble herbicide salt is selected from ALS or AHAS inhibitors, an EPSP inhibitor, a glutamine synthetase inhibitor, synthetic auxins, Photosystem I inhibitors, and combinations thereof. More particularly, the water-soluble herbicide salt can be selected from (i) synthetic auxins including 2,4-D, aminopyralid, clopyralid, dicamba, fluroxypyr, mecoprop, mecoprop-P, picloram and triclopyr, (ii) the Photosystem I inhibitors diquat and paraquat, (iii) the EPSP inhibitor glyphosate, (iv) the glutamine synthetase inhibitor glufosinate and (v) ALS or AHAS inhibitors including imazamethabenz-m, imazamox, imazapic, imazapyr, imazaquin and imazethapyr, racemic mixtures and resolved isomers thereof, and mixtures thereof.

In some embodiments, the water-soluble herbicide salt is a salt of glyphosate. In some other embodiments of the present invention, the water-soluble herbicide salt is a salt of glyphosate, and the compositions further comprise at least one water-soluble, agronomically acceptable salt of a fatty acid predominantly comprising C₈ to C₁₂ saturated, straight or branched chain fatty acids (e.g., water-soluble, agronomically acceptable salts of pelargonic acid). In these and other embodiments, the herbicidal gel compositions of the present invention including a salt of glyphosate or other systemic herbicide are free of certain contact herbicides (e.g., diquat and other bipyridyliums and diphenyl ethers) that may tend to undermine the systemic herbicides effectiveness by inducing too much damage to the foliar tissues of the plant after prolonged contact with the gel. In some preferred embodiments, the herbicidal gel compositions of the present invention including a salt of glyphosate are free of glufosinate and other active ingredients that may have a tendency to exhibit glyphosate antagonism.

Although specific reference is made herein to the glyphosate salt herbicides, one skilled in the art will understand that the principles of the present invention apply to agrochemical salts in general, and the invention is not limited to glyphosate salt herbicidal compositions.

In some embodiments of the present invention, at least one water-insoluble agrochemical (e.g., herbicide) may be optionally added to the agrochemical gel composition (e.g., suspended therein). Examples of suitable water-insoluble herbicides include, without restriction, acetochlor, acifluorfen, aclonifen, alachlor, ametryn, anilofos, atrazine, azafenidin, benfluralin, bensulfuron-methyl, bensulide, benzofenap, bifenox, bromoxynil, butachlor, butroxydim, butylate, cafenstrole, chlomethoxyfen, chlorbromuron, chloridazon, chlornitrofen, chlorotoluron, chlorthal-dimethyl, chlorthiamid, cinmethylin, clethodim, clodinafop-propargyl, cloransulam-methyl, cyanazine, cycloate, cyclosulfamuron, cycloxydim, cyhalofop-butyl, desmedipham, desmetryn, dichlobenil, diflufenican, dimefuron, dimepiperate, dimethachlor, dinitramine, dinoterb, dithiopyr, diuron, EPIC, esprocarb, ethalfluralin, ethametsulfuron-methyl, ethofumesate, fenoxaprop-ethyl, fentrazamide, fluazifop-butyl, fluchloralin, flufenacet, flumiclorac-pentyl, flumioxazin, fluometuron, fluorochloridone, fluoroglycofen, flupyrsulfuron-methyl-sodium, fluridone, fluroxypyr-1-methylheptyl, flurtamone, fluthiacet-methyl, fomesafen, foramsulfuron, furyloxyfen, haloxyfop-methyl, imazosulfuron, ioxynil, isoproturon, isoxaben, isoxaflutole, lactofen, lenacil, linuron, mefenacet, metazachlor, methabenzthiazuron, metobromuron, metolachlor, metosulam, metoxuron, metribuzin, molinate, monolinuron, napropamide, nitrofen, nitrofluorfen, norflurazon, oryzalin, oxadiargyl, oxadiazon, oxasulfuron, oxyfluorfen, pebulate, fatty acids predominantly comprising C₈ to C₁₂ saturated, straight or branched chain fatty acids (e.g., pelargonic acid), pelargonic acid, pendimethalin, phenmedipham, pretilachlor, prodiamine, prometon, prometryn, propachlor, propanil, propaquizafop, propisochlor, propyzamide, prosulfocarb, pyraflufen-ethyl, pyrazolynate, pyrazon, pyrazosulfuron-ethyl, pyrazoxyfen, pyridate, quinclorac, quinmerac, quizalofop-ethyl, rimsulfuron, siduron, simazine, simetryn, sulcotrione, sulfometuron, terbacil, terbumeton, terbuthylazine, terbutryn, thenylchlor, thiazopyr, thiobencarb, triallate, trietazine, trifluralin and vernolate, agriculturally acceptable salts or esters of any of these herbicides, racemic mixtures and resolved isomers thereof, and mixtures and combinations thereof.

Regardless of the particular water-soluble agrochemical (e.g., herbicide), combination of water-soluble agrochemicals, or combinations of one or more water-soluble agrochemicals and at least one water-insoluble herbicide present in the aqueous gel compositions of the present invention, the total agrochemical (e.g., herbicide) concentration is generally in excess of about 0.1 percent by weight (wt %), about 0.5 wt %, about 1 wt %, about 2 wt %, about 3 wt %, or about 4 wt % on an acid equivalent basis. In order to take advantage of the higher loading attained in accordance with the present invention, the total agrochemical (e.g., herbicide) concentration is typically in excess of about 5 wt %, about 5.5 wt %, about 6 wt %, about 6.5 wt %, about 7 wt % or about 7.5 wt % on an acid equivalent basis. In various embodiments, the total agrochemical (e.g., herbicide) concentration is from about 3 to about 20 wt %, from about 4 to about 20 wt %, from about 5 to about 20 wt %, from about 5.5 to about 20 wt %, from about 6 to about 20 wt %, from about 6 to about 15 wt %, from about 6.5 to about 15 wt %, from about 7 to about 15 wt %, from about 6 to about 12 wt %, from about 6.5 to about 12 wt %, from about 7 to about 12 wt %, or from about 6 to about 10 wt % on an acid equivalent basis.

The aqueous gel compositions of the present invention have a total water content of from about 70 to about 94 percent by weight (wt %) water, from about 75 to about 92 wt % water, from about 80 to about 90 wt % water, from about 82 to about 90 wt % water, from about 84 to about 90 wt % water, from about 85 to about 90 wt % water, or from about 85 to about 88 wt % water.

The gel forming agents used in the instant invention are polymeric materials selected to achieve certain rheological characteristics and to ensure the composition retains its gel form and desired rheological properties as the concentration of the water-soluble agrochemical salt component increases.

In accordance with one embodiment, the gel forming agent comprises a crosslinked homopolymer (e.g., prepared from acrylic acid) wherein the monomer is polymerized in the presence of a steric stabilizer to form an interpolymer as described in U.S. Pat. No. 5,288,814, the entire disclosure of which is incorporated herein by reference. More specifically, the polymeric gel forming agent comprises an interpolymer of a) at least one olefinically unsaturated carboxylic acid or anhydride containing at least one activated carbon-to-carbon olefinic double bond and at least one carboxyl group, in an amount of more than about 15% by weight based upon the weight of interpolymer, and b) at least one steric stabilizer having at least one hydrophilic moiety and at least one hydrophobic moiety.

The at least one steric stabilizer is suitably selected from the group consisting of linear block copolymeric steric stabilizers, having a hydrophobic moiety having a length of more than about 50 Angstroms, random copolymeric comb steric stabilizers, and mixtures thereof. Typically, the steric stabilizer may be present in an amount of from about 0.001 to about 20%, from about 0.001 to about 15%, from about 0.1 to about 10%, or from about 0.2 to about 6% by weight based upon the weight of the carboxylic acid or anhydride.

In some embodiments when the steric stabilizer is a linear block copolymeric steric stabilizer, it is defined by the formula:

C_{w}(B-A-B_{y})ₓD_{z}

wherein A is a hydrophilic moiety having a solubility in water at 25° C. of 1% or greater, a molecular weight of from about 200 to about 50,000, and selected to be covalently bonded to the B blocks; B is a hydrophobic moiety having a molecular weight of from about 300 to about 60,000, a solubility of less than 1% in water at 25° C., capable of being covalently bonded to the A blocks; C and D are terminating groups which can be A or B, can be the same or different groups, and will depend upon the manufacturing process since they are present to control the polymer length, to add other functionality, or as a result of the manufacturing process; w is 0 or 1; x is an integer of 1 or more; y is 0 or 1; and z is 0 or 1.

Examples of suitable hydrophillic groups include, but are not limited to, polyethylene oxide, poly(1,3-dioxolane), copolymers of polyethylene oxide or poly(1,3-dioxolane), poly(2-methyl-2-oxazoline polygycidyl trimethyl ammonium chloride, polymethylene oxide, and the like, with polyethylene oxide being preferred. Examples of suitable hydrophobic groups include, but are not limited to, polyesters, such as those derived from 2-hydroxybutyric acid, 3-hydroxybutyric acid, 4-hydroxybutyric acid, 2-hydroxycaproic acid, 10-hydroxydeanoic acid, 12-hydroxydodecanoic acid, 16-hydroxyhexadecanoic acid, 2-hydroxyisobutyric acid, 2-(4-hydroxyphenoxy)propionic acid, 4-hydroxyphenylpyruvic acid, 12-hydroxystearic acid, 2-hydroxyvaleric acid, polyactones, such as caprolactone, butyrolactone, polyactames, such as those derived from caprolactam, polyurethanes, polyisobutylene, where the hydrophobe should provide a stearic barrier greater than about 50 Angstroms, preferably greater than about 75 Angstroms, with greater than about 100 Angstroms being also preferred, and the like, with polyhydroxy fatty acids, such as poly(l2-hydroxystearic acid) being preferred. The steric barrier is the length of the hydrophobe in its fully-extended condition.

In some embodiments the block copolymer of the interpolymer is a block copolymer of 12-hydroxystearic acid such as a block copolymer with polyethylene oxide or an ABA block copolymer.

The carboxylic acid of the interpolymer is suitably selected from the group consisting of acrylic acid, methacrylic acid, and maleic acid. In one embodiment, the carboxylic acid of the interpolymer is acrylic acid. The carboxylic acid or anhydride is typically present in amounts greater than about 15 weight percent, greater than about 20 weight percent, greater than about 30 weight percent, or greater than about 40 weight percent based upon the weight of the interpolymer.

In some embodiments, there is present in the interpolymer less than about 30 weight percent, less than about 20 weight percent, less than about 10 weight percent, or less than about 5 weight percent based upon the weight of the carboxylic acid or anhydride of a polyfunctional crosslinking vinylidene monomer containing at least two terminal CH₂<groups. The crosslinking monomer may be suitably selected from the group consisting of allyl pentaerythritol, allyl sucrose, and trimethylolpropane diallylether.

In some embodiments the gel compositions of the present invention may be rheologically characterized by tan(delta), static or stationary viscosity, yield point, and pseudoplasticity. Compositions of the present invention having a tan(delta) value as described herein will retain sufficient energy when a stress or strain is applied, for example by application methods such as rolling, brushing or passing the composition through a nozzle, to substantially return to its previous condition and exhibit excellent stand-up when the stress or strain is removed. The compositions will also have a high cohesive property, namely, when a shear or strain is applied to a portion of the composition to cause it to flow, the surrounding portions will follow. As a result of this cohesiveness, the gel compositions of the present invention exhibit good retention on plant material and resist run-off. Moreover, the cohesiveness contributes to the physical (phase) stability of the gel compositions and resistance to phase separation of any undissolved suspended particles by providing a resistance to movement of the particles due to the strain exerted by a particle on the surround fluid medium.

Tan(delta) is expressed as G″/G′ where G″ is the viscous (loss) modulus and G′ is the elastic (storage) modulus of the gel. By way of further explanation, the elastic (storage) modulus G′ is a measure of the energy stored and retrieved when a strain is applied to the composition while viscous (loss) modulus G″ is a measure to the amount of energy dissipated as heat when strain is applied. Expressed another way, G′ is a measure of the ability of a composition to store recoverable energy. This energy storage can be the result of the ability of a complex polymer, structural network, or a combination of these to recover stored energy after a deformation. G″ is a measure of the unrecoverable energy which has been lost due to viscous flow. A tan(delta) in the preferred range indicates that the elastic component of the gel predominates.

Tan(delta) can be measured by methods known to those skilled in the art. For instance, tan(delta) may be determined by using a mechanical spectrometer, such as model RMS-800, available from TA Instruments, Ltd. in New Castle, Del., USA (formerly, Rheometrics, Inc. in Piscataway, N.J., USA). In the evaluation, a disk-like composition sample, for example measuring about 2.5 mm in thickness and about 25 mm in diameter, is placed between opposed, axially spaced apart, radially-extending surfaces and the sample is in connection with each surface thereby filling a portion of the axial spacing between the surfaces. At a selected temperature (for instance 25° C.), one of the surfaces then is rotated about the axial direction relative to the other at a selected oscillating frequency (for instance one Radian per second) in order to place the test specimen under shear conditions. The torque resulting from the shear is measured. The shear may be steady shear, in which case the measured torque is constant, or the shear may be dynamic shear, in which case the measured torque changes continuously with time. The measured torque is proportional to the viscous, or loss component of the modulus (G″) of the material. Typically, the shear is steady shear, meaning the measured torque, and thus G″, is constant at the given temperature. As a result of the nature of the forces applied to the test specimen in this procedure, the test specimen has a tendency to expand axially, thereby placing axially directed forces upon the relatively rotating surfaces to which the specimen is coupled. This axial force exerted upon the surfaces by the test specimen under shear conditions is proportional to the elastic, or storage component of the modulus (G′) of the material. The parameter tan(delta) is then calculated as G″ divided by G′ at the stated temperature and oscillating frequency. The gel compositions of the present invention preferably have a tan(delta) value of less than about 1, less than about 0.9, less than about 0.8, less than about 0.7, less than about 0.6, less than about 0.5, less than about 0.4, or less than about 0.3, for example about, 1, 0.9, 0.8, 0.7, 0.6, 0.5, 0.4, 0.3, 0.2, 0.1 or 0.05 and ranges thereof, such as from about 0.05 to about 1, from about 0.05 to about 0.9, from about 0.05 to about 0.8, from about 0.05 to about 0.7, from about 0.05 to about 0.6, from about 0.05 to about 0.5, from about 0.05 to about 0.4 or from about 0.05 to about 0.3.

In some embodiments of the present invention, tan(delta) is determined by oscillation frequency sweep rheometric measurements between about 0.1 and about 600 rad/sec at 0.2 Pa and 1 Pa as measured on a TA rheometer with a 60 mm 2° acrylic cone and plate at 20° C. G′ and G″ in Pa are measured and tan(delta) is calculated as G″/G′.

The compositions of the present invention preferably are pseudoplastic gels defined as having a viscosity that decreases with increasing shear rate (also termed shear thinning). Such gels exhibit a relatively low viscosity under high-shear conditions and a relatively high viscosity under low or no shear conditions. Consequently, the gels of the present invention have a high stationary viscosity (i.e. viscosity when not subjected to shear), but low viscosity when subjected to shear thereby resulting in a thin (low viscosity) solution that can be easily dispensed and applied to plant foliage, for example, as a fine spray or by direct application through, for instance, rolling or brushing. Stationary viscosity can also be termed “yield value” or “maximum viscosity” wherein each term refers to a measure of a gel's initial resistance to flow under shear. After application to plant material, a perfectly pseudoplastic gel regains all of its stationary viscosity in response to the absence of shear. The high stationary viscosity provides good foliage surface cling (inhibits dripping or flow of the compositions from non-horizontal leaf surfaces) and enhances the ability of the applied compositions to remain on the leaf after deposition, and not be dislodged or washed away from the surface during ordinary conditions of use.

Yield point is typically defined as the threshold shear stress that must be applied to induce flow of a fluid. In some embodiments the compositions of the present invention preferably have a yield point that allows for application of a flowable composition by mechanical methods having relatively low shear stress, such as by brushing or roll-on application, but is yet high enough to ensure that the gel is retained on the foliar tissues once the external stress is removed. The yield point of the gel compositions in accordance with some embodiments of the present invention is preferably at least about 50, 75, 100, 125, 150, 175, 200, 300, 400, 500, 600, 700, 800, 900, 1,000, 2,000, 3,000, 4,000 or 5,000 dyne/cm² or higher, and ranges thereof, for example, such as from about 50 to about 5,000 dyne/cm², from about 50 to about 4,000 dyne/cm², from about 50 to about 3,000 dyne/cm², from about 100 to about 2,000 dyne/cm² or from about 100 to about 1,000 dyne/cm². Like tan(delta), yield point for a gel composition can be readily determined using conventional equipment and methods known to those skilled in the art. Suitable means for determining yield point and tan(delta) are disclosed in International Application Publication No. WO 2011/113061, the entire contents of which is incorporated herein by reference.

In some embodiments of the invention, the gel compositions may exhibit some degree of thixotropy, i.e, the gels are not perfectly pseudoplastic, wherein viscosity is reduced by shear, as described above, but in contrast to a perfectly pseudoplastic liquid (which regains all of its stationary viscosity when the shear stress is removed), the viscosity of a thixotropic gel does not immediately return to its original value when the shear stress is removed. While pseudoplastic properties are the most desired for this invention, almost all compositions will exhibit some acceptable degree of thixotropy.

Viscosity of the gels of the present invention can be measured by methods known to those skilled in the rheological arts. For example, cone and plate-type viscometers as available from TA Instruments, Ltd., Haake and Brookfield are suitable for viscosity measurement. Similarly, spindle-type viscometers as available from Haake or Brookfield can be used. For instance, stationary viscosity could be measured with a Brookfield RVT rotational viscosimeter fitted to a HELIPATH stand and with a TA spindle, at 1 r.p.m. and 25° C. In an optional method for measuring stationary viscosity of the pseudoplastic gels of the present invention, viscosity could be measured at varying shear rates. A zero-shear viscosity can be then be accurately estimated by linear regression of the collected viscosity versus shear data. A stationary viscosity measured as a function of shear rate (using, for instance, an AR 200 Advanced Rheometer (available from TA Instruments, Ltd.) with a 60 mm 2° acrylic cone and plate at 20° C. with an oscillating frequency of 100 rad/s) of greater than about 500 mPa second is preferred, such as about 1,000, 2,000, 3,000, 4,000, 5,000, 10,000, 20,000, 30,000, 40,000, 50,000, 75,000, 100,000 or about 150,000 mPa second. Viscosity ranges thereof, such as from about 500, 1,000, 2,000, 3,000, 4,000, 5,000, 10,000, 25,000 or 50,000 to about 150,000 mPa second, from about 500, 1,000, 2,000, 3,000, 4,000, 5,000, 10,000, 25,000 or 50,000 to about 100,000 mPa second, from about 500, 1,000 2,000, 3,000, 4,000, 5,000, 10,000, or 25,000 to about 50,000 mPa, or from about 500, 1,000 2,000, 3,000, 4,000, 5,000, 10,000, 25,000 to about 25,000 mPa second are preferred.

Generally, the rheological characteristics of the compositions of the present invention vary depending on the identity and concentration of the gel forming agent, the identity and concentration of the water-soluble agrochemical (e.g., herbicide) salt component, on the identity and concentration of the water-insoluble herbicide component (if present) and on the identity and concentration of a surfactant component (if present). The gel forming agent concentration, on an active basis, in the compositions of the present invention is typically from about 0.1 to about 5 wt %, from about 1 to about 5 wt %, from about 1 to about 4 wt % from about 1 to about 3 wt %, from about 2 to about 5 wt %, from about 2 to about 4 wt % or from about 2 to about 3 wt %. As used herein, the active basis concentration of a gel forming agent relates to the concentration of the active gel forming agent in the gel.

The rheological characteristics of the aqueous gel compositions of the present invention may be affected by pH. Accordingly, if necessary, a pH adjuster may be added to the gel composition. Typically, agrochemical gel compositions prepared in accordance with the present invention have a pH of from about 6 to 7.5.

The compositions of the present invention typically comprise one or more preservatives. Preservatives, when used, include, but are not limited to, biocides such mildewstats and bacteriostats. Examples include methyl, ethyl and propyl parabens; short chain organic acids (e.g. acetic, lactic and/or glycolic acids); bisguanidine compounds (e.g. Dantagard and/or Glydant); short chain alcohols (e.g. ethanol and/or IPA); 5-chloro-2-methyl-4-isothiazolin-3-one (KATHON GC), 2-methyl-4-isothiazolin-3-one (KATHON ICP), 5-chloro-2-methyl-4-isothiazolin-3-one (KATHON 886), all available from Rohm and Haas Company; 2-bromo-2-nitropropane 1, 3 diol (BRONOPOL), from Boots Company Ltd.; propyl-p-hydroxybenzoate (PROXEL CRL), from ICI PLC; 1,2-Benzisothiazol-3(2H)-one biocide (PROXEL GXL) from Zeneca Specialties Co.; o-phenyl-phenol, Na⁺ salt (NIPASOL M) from Nipa Laboratories Ltd.; 1,2-Benzoisothiazolin-3-one (DOWICIDE A) and 1-(3-chloroallyl)-3,5,7-triaza-1-azoniaadamantane chloride (DOWICIL 75 or 150), from Dow Chemical Co.; quaternary alkyl ammonium chloride in 2-propanol (ARQUAD 2.8-50) from Akzo Nobel; and 2,4,4′-trichloro-2-hydroxydiphenylether (IRGASAN DP 200), from Ciba-Geigy A.G.

The herbicidal performance of the gels of the present invention is not believed to be significantly affected by the presence of a surfactant. Without being bound to any particular theory, it is believed that the gels provide enhanced plant material contact time and a reduced drying rate thereby allowing efficient herbicide uptake and/or translocation even in the absence of a surfactant. Nonetheless, in some embodiments of the present invention, herbicidal efficacy enhancing surfactants known in the art can optionally be added to the gels. Suitable optional surfactants for inclusion in the gels of the present invention are described in International Application Publication No. WO 2011/113061 and include akoxylated tertiary etheramine, alkoxylated quaternary etheramine, alkoxylated tertiary amine oxide, alkoxylated tertiary amine, alkoxylated quaternary amine, alkoxylated etheramine oxide, polyamine, sulfate derivative, sulfonate derivative, phosphate ester of alkoxylated alcohol, alkyl polysaccharide, alkoxylated alcohol, amidoalkylamine, and combinations and mixtures thereof. If a surfactant component is included, the weight ratio of agrochemical (e.g., herbicide) salt, on an a.e. basis, to surfactant of from about 1:1 to about 20:1, from about 2:1 to about 10:1 or from about 3:1 to about 8:1 may be employed.

The aqueous agrochemical gel compositions may further comprise other conventional adjuvants such as solvents, emulsifiers, chelating agents, emollients, permeation enhancers, antioxidants, lubricants, adjuvants, dyes, conventional drift control agents, safeners, thickeners, flow enhancers, antifoaming agents, freeze protectants and/or UV protectants. These other additives or ingredients may be introduced into the compositions of the present invention to provide or improve certain desired properties or characteristics of the formulated product.

Generally, the aqueous gel compositions of the instant invention may be prepared by mechanically admixing an aqueous solution comprising the gel forming agent in which the gel forming agent has been dispersed and sufficiently hydrated with one or more agrochemical (e.g., herbicide) salts, and other ingredients. The pseudoplastic characteristics of the gel compositions provide for advantages in processing. The agrochemical salt and gel forming agents can be combined with agitation, having sufficient shear to cause a composition viscosity decrease. The resulting thin composition increases mixing efficiency minimizes power consumption and heat generation and thus maximizes processing efficiency. In a preferred embodiment the polymeric gel forming agent is dispersed and hydrated in water, followed by addition and mechanically admixing of the water-soluble agrochemical salt component and any other ingredients. Once a homogeneous mixture is obtained, the pH of the mixture is increased by addition of a base (e.g., KOH) to adjust and achieve the desired viscosity. When dispersed in water, the polymeric gel forming agent begins to hydrate, but typically will not form a gel at lower pH (e.g., less than about 5). However, composition viscosity rapidly increases as the pH is increased. When the hydrated polymeric gel forming agent is neutralized with a base, a thickened aqueous solution results. Combining the components of the agrochemical gel composition in this manner allows for easier preparation because the composition does not become viscous until the neutralization of the hydrated gel forming agent.

The present invention is further directed to methods of confined application of agrochemical gels to unwanted plants such as trees, bushes, weeds, and/or certain crop plants such as volunteer crops that germinate and grow from a seed remaining after the harvest of a prior crop plant. As explained above, in some embodiments, the ready-to-use (RTU) gel compositions of the present invention can be directly applied to the foliage or exposed areas of individual plants such as by spraying from hand-held sprayers (e.g. a spray bottle), canisters or tanks, or by applicators such as brushes, rollers or sponges. In other embodiments, the gels can broadcast applied to larger areas containing unwanted plant growth my methods known in the art such as by applying to a foliage canopy by spraying. The shear generated during pumping, brushing, shaking, stirring or transfer through a spray nozzle reduces gel viscosity to allow the composition to flow and thereby facilitate the efficient application or dispersal of the gel composition.

In more detail, in accordance with the present invention, the ready-to-use (RTU) aqueous gel compositions may be directly applied to plant material by any of various means known in the art including, but not limited to, (i) application to a foliage canopy using aerial spraying systems, farm-scale ground based spraying application such as from a truck or trailer mounted system, or hand-held spraying methods such as from a canister or tank or (ii) targeted application to plant foliage of individual plants by using hand-held sprayers, brushes, rollers, sponges, wick applicators. The gel compositions can be optionally applied to non-foliar plant tissue by methods including (i) cut stump application wherein the plant is cut off completely at its base leaving a stump and root system, and the gel composition is applied onto the cut surface of the stump, (ii) cut and swab application wherein plants such as vines or multi-stemmed shrubs are cut completely through and the gel composition is applied to the cut surface emerging from the ground, (iii) stem scraping wherein a thin layer of bark is scraped or otherwise removed from a section of a stem and the gel composition is applied to the exposed plant tissue or (iv) hack and squirt application wherein a ring of bark is removed from the trunk of the plant, typically using downward cuts, leaving a reservoir or “cup” to hold applied agrochemicals into which the gel composition is then applied and thereby exposed plant tissue in the cut area.

After the gel composition is applied to the plant (such as onto foliage), where low or zero shear conditions are present, the viscosity increases to about the viscosity observed under static conditions. The retention time on the plant is significantly enhanced due to the rheological properties of the gel as previously described. For example, as compared to broadcast applied herbicide or tank mixed herbicides known in the art, the substantially greater stationary viscosity and elastic nature of the gels of the present invention improves adhesion and retention time on the plant. In addition, the applied gel compositions of the present invention resist drying and have an ability to retain moisture content for significantly longer durations in comparison to broadcast applied herbicide or tank mixed herbicides of the prior art.

Unwanted plants within the scope of the present inventions include, without limitation, woody weeds, weeds and/or volunteer crop plants. Examples of woody weeds include ailanthus altissima, alnus glutinosa, artemisia sp., bromus madritensis, chamerion angustifolium, cirsium arvense, cistus crispus, cistus salviifolius, corylus avellana var. grandis, elaeagnus, angustifolia, fallopia japonica, fraxinus angustfolia oxycarpa, fraxinus excelsior, hedera helix, potentilla aurea, prunus avium, prunus spinosa, quercus ilex, rhododendron ponticum, rubia peregrina, rubus fruticosus, rubus idaeus, rubus sp., rubus ulmifolius, salix babylonica, sambucus nigra, schinus molle, trifolium repens, ulex europaeus, ulmus sp., urtica dioica, urtica sp., urtica thunbergiana, and urtica urens. Volunteer crop plants of the present invention include hybrids, inbreds, and transgenic or genetically modified plants such as, vegetable crops, grain crops, flowers, root crops and sod. Examples of volunteer crop plants include corn, cotton and soybeans. Weeds include velvetleaf (Abutilon theophrasti), pigweed (Amaranthus spp.), buttonweed (Borreria spp.), indian mustard (Brassica spp.), commelina (Commelina spp.), filaree (Erodium spp.), sunflower (Helianthus spp.), morningglory (Ipomoea spp.), kochia (Kochia scoparia), mallow (Malva spp.), wild buckwheat, smartweed (Polygonum spp.), purslane (Portulaca spp.), russian thistle (Salsola spp.), sida (Sida spp.), wild mustard (Sinapis arvensis), cocklebur (Xanthium spp.), wild oat (Avena fatua), carpetgrass (Axonopus spp.), downy brome (Bromus tectorum), crabgrass (Digitaria spp.), barnyardgrass (Echinochloa crus-galli), goosegrass (Eleusine indica), annual ryegrass (Lolium multiflorum), ottochloa (Ottochloa nodosa), bahiagrass (Paspalum notatum), canarygrass (Phalaris spp.), foxtail (Setaria spp.), mugwort (Artemisia spp.), milkweed (Asclepias spp.), canada thistle (Cirsium arvense), field bindweed (Convolvulus arvensis), kudzu (Pueraria spp.), brachiaria (Brachiaria spp.), bermudagrass (Cynodon dactylon), yellow nutsedge (Cyperus esculentus), purple nutsedge (C. rotundas), quackgrass (Elymus repens), lalang (Imperata cylindrica), perennial ryegrass (Lolium perenne), guineagrass (Panicum maximum), dallisgrass (Paspalum dilatatum), reed (Phragmites spp.), johnsongrass (Sorghum halepense), cattail (Typha spp.), horsetail (Equisetum spp.), bracken (Pteridium aquilinum), blackberry (Rubus spp.), and gorse (Ulex europaeus).

### EXAMPLES

The following non-limiting examples are provided to further illustrate the present invention.

Test aqueous gel formulations were prepared by mechanically admixing the water-soluble agrochemical salt component (e.g., potassium glyphosate) with a pre-mix solution of the hydrated polymeric gel forming agent to obtain a homogeneous mixture, followed by addition of the preservative, pelargonic acid (if present) and finally base to adjust the pH and achieve the desired viscosity.

### Example 1

In Table I, “K-gly” refers to glyphosate potassium salt, and wt % gel refers to weight percent gel forming agent on an active basis. The gel forming agent used in this Example was a crosslinked homopolymer (e.g., prepared from acrylic acid) wherein the monomer is polymerized in the presence of a steric stabilizer to form an interpolymer as described above and in U.S. Pat. No. 5,288,814 and commercially available from The Lubrizol Corporation. The amount of water present in the formulation was reported as wt % water based upon the total weight of the formulation.

TABLE I
Test Formulations

| Formulation | (1) | (2) | (3) |
|---|---|---|---|
| K-gly (wt % a.e.) | 6.71 | 6.71 | 6.71 |
| wt % gel | 2.50 | 2.50 | 2.5 |
| Kathon CG/ICP (wt %) | 0.09 | — | — |
| Dowicil 150 (wt %) | — | 0.05 | 0.05 |
| Pelargonic acid | — | — | 2.00 |
| Base | KOH | KOH | KOH |
| 45% KOH (wt % a.i.) | 2.90 | 2.90 | 3.62 |
| Water (wt %) | 86.32 | 87.84 | 85.12 |
| pH | nd | 6.2 | 6.95 |
| Density | nd | 1.076 | 1.1 |

nd = not determined

A tan delta value was determined for Formulations (1) and (3) using a TA rheometer with a 60 mm 2° acrylic cone and plate at 20° C. at 1% strain. The result is provided below in Table Ia.

TABLE Ia
Tan Delta

| Formulation | Frequency (Hz) | Tan Delta |
|---|---|---|
| (1) | 1 | 0.084 |
| (3) | 1 | 0.12 |

Yield point and viscosity data were also measured for Formulations (1) and (3). The values were determined using the TA rheometer with the cone and plate geometry and viscosity was measured as a function of shear rate. The resulting curve was then fitted with Bingham rheological model, and yield point and viscosity were calculated based on these curves. In the Bingham rheological model, a fluid is presumed not to flow until an applied shear stress, τ, exceeds a minimum value, τ0. This minimum value of shear stress is known as the “yield point” (YP). At stress levels above the YP, changes in shear stress become proportional to the changes in the shear rate. The proportionality constant is known as the plastic viscosity (PV), represented in the equation below as γ. The Bingham Plastic model can be represented by the following expression:

τ=τ₀+μ_{B}γ

wherein γ is the proportionality constant, also known as the plastic viscosity (PV) and μ_{B} is the constant Bingham viscosity. The data is provided in Table Ib.

TABLE Ib

| | | | K-gly (wt % |
|---|---|---|---|
| | Yield Pt | Viscosity | a.e.) |
| Formulation | (dyne/cm²) | (poise) | Loading |
| (1) | 430-470 | 12.67 | 6.71 |
| (3) | nd | 508.87 | 6.71 |

nd = not determined

### Example 2

In Table II, “K-gly” refers to glyphosate potassium salt, and wt % gel refers to weight percent gel forming agent on an active basis. The gel forming agent used in this Example was a crosslinked homopolymer (e.g., prepared from acrylic acid) wherein the monomer is polymerized in the presence of a steric stabilizer to form an interpolymer as described above and in U.S. Pat. No. 5,288,814 and commercially available from The Lubrizol Corporation.

TABLE II
Test Formulations

| | | | | Brookfield | |
|---|---|---|---|---|---|
| | | | 45% | Viscosity | |
| | K-gly | | KOH | @ 2 rpm | |
| | (wt % | wt % | (wt % | spindle | pH |
| Formulation | a.e.) | gel | a.i.) | T-B (cps) | (5%) |
| (4) | 4.59 | 1.8 | 6 | 14,000 | 6.43 |
| (5) | 4.59 | 1.8 | 8 | 26,900 | 9.82 |
| (6) | 6.06 | 1.8 | 9.49 | 22,000 | 9.69 |
| (7) | 4.61 | 1.8 | 7.01 | 33,600 | 7.77 |
| (8) | 4.59 | 3.2 | 6.01 | 116,000 | 6.06 |
| (9) | 4.59 | 3.2 | 7.99 | 126,000 | 6.88 |
| (10) | 7.56 | 1.8 | 6 | 12,300 | 5.88 |
| (11) | 7.16 | 1.71 | 7.59 | 10,800 | 6.46 |
| (12) | 7.56 | 3.24 | 6.5 | 83,400 | 5.76 |
| (13) | 7.56 | 3.2 | 6 | 100,000 | 5.46 |
| (14) | 7.55 | 3.21 | 9.55 | 108,000 | 6.57 |
| (15) | 4.36 | 2.5 | 8.49 | 75,700 | 9.52 |
| (16) | 7.94 | 2.5 | 8.49 | 60,900 | 6.36 |
| (17) | 6.14 | 1.65 | 8.49 | 18,900 | 9.02 |
| (18) | 7.94 | 1.65 | 8.5 | 6,480 | 6.76 |
| (19) | 6.13 | 1.65 | 5.99 | 14,500 | 6.15 |
| (20) | 6.14 | 3.2 | 8.49 | 90,600 | 6.5 |
| (21) | 7.94 | 3.2 | 8.48 | 102,000 | 6.15 |
| (22) | 6.08 | 2.48 | 6.19 | 71,900 | 5.97 |
| (23) | 6.14 | 2.5 | 9.24 | 90,400 | 7.44 |
| (24) | 6.14 | 2.5 | 8.47 | 83,200 | 6.66 |
| (25) | 6.14 | 2.5 | 8.35 | 123,000 | 6.44 |

A tan delta value was determined using a TA rheometer with a 60 mm 2° acrylic cone and plate at 20° C. at 1% strain. The frequency was 1 Hz. The result is provided below in Table IIa.

TABLE IIa
Tan Delta

| Formulation | tan(δ) |
|---|---|
| (4) | 0.141 |
| (5) | 0.136 |
| (6) | 0.271 |
| (7) | 0.114 |
| (8) | 0.090 |
| (9) | 0.089 |
| (10) | 0.529 |
| (11) | 0.193 |
| (12) | 0.100 |
| (13) | 0.095 |
| (14) | 0.086 |
| (15) | 0.103 |
| (16) | 0.136 |
| (17) | 0.157 |
| (18) | 0.407 |
| (19) | 0.293 |
| (20) | 0.108 |
| (21) | 0.104 |
| (22) | 0.098 |
| (23) | 0.105 |
| (24) | 0.098 |
| (25) | 0.092 |

Yield point and viscosity data were also measured in accordance with the protocol of Example 1. The data is provided in Table IIb.

TABLE IIb

| | | | K-gly (wt % |
|---|---|---|---|
| | Yield Pt | Viscosity | a.e.) |
| Formulation | (dyne/cm²) | (poise) | Loading |
| (4) | 130 | 167.02 | 4.59 |
| (5) | 156 | 202.56 | 4.59 |
| (6) | 67.5 | 85.38 | 6.06 |
| (7) | 234 | 290.27 | 4.61 |
| (8) | 773 | 946.54 | 4.59 |
| (9) | 847 | 1037.43 | 4.59 |
| (10) | 71.1 | 90.19 | 7.56 |
| (11) | 77 | 97.60 | 7.16 |
| (12) | 638 | 788.57 | 7.56 |
| (13) | 712 | 877.03 | 7.56 |
| (14) | 793 | 928.06 | 7.55 |
| (15) | 509 | 648.40 | 4.36 |
| (16) | 378 | 483.74 | 7.94 |
| (17) | 128 | 161.19 | 6.14 |
| (18) | 27.3 | 33.83 | 7.94 |
| (19) | 86.4 | 106.67 | 6.13 |
| (20) | 670 | 817.60 | 6.14 |
| (21) | 707 | 880.61 | 7.94 |
| (22) | 478 | 601.39 | 6.08 |
| (23) | 503 | 641.36 | 6.14 |
| (24) | 559 | 746.96 | 6.14 |
| (25) | 758 | 877.25 | 6.14 |

### Example 3

In Table III, “K-gly” refers to glyphosate potassium salt, and wt % gel refers to weight percent gel forming agent on an active basis. The gel forming agent used in this Example was a crosslinked homopolymer (e.g., prepared from acrylic acid) wherein the monomer is polymerized in the presence of a steric stabilizer to form an interpolymer as described above and in U.S. Pat. No. 5,288,814 and commercially available from The Lubrizol Corporation. The amount of water present in the formulation was reported as wt % water based upon the total weight of the formulation.

TABLE III
Test Formulations

| Formulation | (26) | (27) |
|---|---|---|
| K-gly (wt % a.e.) | 6.71 | 6.71 |
| wt % gel | 1.0 | 3.03 |
| Proxel GXL | 0.1 | 0.1 |
| 45% KOH (wt % a.i.) | 2.99 | 4.27 |
| Water (wt %) | 89.2 | 85.9 |
| pH | 7 | 7.71 |

A tan delta value was determined for using a TA rheometer with a 60 mm 2° acrylic cone and plate at 20° C. at 1% strain. The frequency was 1 Hz. The result is provided below in Table IIIa.

TABLE IIIa
Tan Delta

| Formulation | tan(δ) |
|---|---|
| (26) | 0.225 |
| (27) | 0.085 |

Yield point and viscosity data were also measured in accordance with the protocol of Example 1. The data is provided in Table IIIb.

TABLE IIIb

| | | | K-gly (wt % |
|---|---|---|---|
| | Yield Pt | Viscosity | a.e.) |
| Formulation | (dyne/cm²) | (poise) | Loading |
| (26) | 148.83 | 137.05 | 6.71 |
| (27) | 1213.89 | 1351.37 | 6.71 |

The gel formulations were highly elastic in nature as demonstrated by a tan(delta) value much lower than 1 and the calculated yield point provides a low run-off potential of the gel when applied to plant material surfaces.

When introducing elements of the present invention or the preferred embodiments(s) thereof, the articles “a”, “an”, “the” and “said” are intended to mean that there are one or more of the elements. The terms “comprising”, “including” and “having” are intended to mean that there may be additional elements other than the listed elements.

In view of the above, it will be seen that the several objects of the invention are achieved and other advantageous results attained.

As various changes could be made in the above compositions and processes without departing from the scope of the invention, it is intended that all matter contained in the above description shall be interpreted as illustrative and not in a limiting sense.

What is claimed is:

1. An aqueous agrochemical gel composition comprising:
from about 3 to about 20 percent by weight (wt %) on an acid equivalent basis of a water-soluble agrochemical salt component,
from about 0.1 to about 5 percent by weight (wt %) of a polymeric gel forming agent component comprising an interpolymer of
a) at least one olefinically unsaturated carboxylic acid or anhydride containing at least one activated carbon-to-carbon olefinic double bond and at least one carboxyl group, in an amount of more than about 15% by weight based upon the weight of interpolymer, and
b) at least one steric stabilizer having at least one hydrophilic moiety and at least one hydrophobic moiety, selected from the group consisting of linear block copolymeric steric stabilizers, having a hydrophobic moiety having a length of more than about 50 Angstroms, random copolymeric comb steric stabilizers, and mixtures thereof, and
from about 70 to about 94 percent by weight (wt %) water.

2. The gel composition of claim 1 wherein said steric stabilizer is present in an amount of about 0.001 to about 15% by weight based upon the weight of the carboxylic acid or anhydride.

3. The gel composition of claim 2 wherein said steric stabilizer is present in the amount of about 0.1 to about 10% by weight based upon the weight of said carboxylic acid or said anhydride.

4. The gel composition of claim 3 wherein said steric stabilizer is present in an amount of about 0.2 to about 6% by weight based upon the weight of said carboxylic acid or said anhydride.

5. The gel composition of any one of claims 1 to 4 wherein said linear block copolymeric steric stabilizer is defined by the following formula:
C_{w}(B-A-B_{y})ₓD_{z},
wherein A is a hydrophilic moiety having a solubility in water at 25° C. of 1% or greater, a molecular weight of from about 200 to about 50,000, and selected to be covalently bonded to B;
B is a hydrophobic moiety having a molecular weight of from about 300 to about 60,000, a solubility of less than 1% in water at 25° C., capable of being covalently bonded to A;
C and D are terminating groups which can be A or B, can be the same or different groups;
w is 0 or 1;
x is an integer of 1 or more;
y is 0 or 1; and
z is 0 or 1.

6. The gel composition of any one of claims 1 to 4 wherein said block copolymer is a block copolymer of 12-hydroxystearic acid.

7. The gel composition of claim 6 wherein said polymer of 12-hydroxystearic acid is a block copolymer with polyethylene oxide.

8. The gel composition of claim 6 wherein said polymer of 12-hydroxystearic acid is an ABA block copolymer.

9. The gel composition of any one of claims 1 to 4 wherein said carboxylic acid is selected from the group consisting of acrylic acid, methacrylic acid, and maleic acid.

10. The gel composition of any one of claims 1 to 4 wherein said carboxylic acid or anhydride is present in an amount greater than about 40 weight percent based upon the weight of the interpolymer.

11. The gel composition of any one of claims 1 to 4 wherein there is present in the interpolymer less than about 5 weight percent based upon the weight of the carboxylic acid or anhydride of a polyfunctional crosslinking vinylidene monomer containing at least two terminal CH₂<groups.

12. The gel composition of claim 11 wherein said crosslinking monomer is selected from the group consisting of allyl pentaerythritol, allyl sucrose, and trimethylolpropane diallylether.

13. The gel composition of any one of claims 1 to 4 wherein the yield point of the gel composition is at least about 50, 75, 100, 125, 150, 175, 200, 300, 400, 500, 600, 700, 800, 900, 1,000 or 5,000 dyne/cm².

14. The gel composition of claim 13 wherein the yield point of the gel composition is from about 50 to about 5,000 dyne/cm².

15. The gel composition claim 13 wherein the yield point range is from about from about from about 50 to about 4,000 dyne/cm², from about 50 to about 3,000 dyne/cm², from about 100 to about 2,000 dyne/cm² or from about 100 to about 1,000 dyne/cm².

16. The gel composition of any one of claims 1 to 4 wherein tan(delta) of the gel composition is less than about 1, less than about 0.9, less than about 0.8, less than about 0.7, less than about 0.6, less than about 0.5, less than about 0.4, or less than about 0.3 as measured by oscillation frequency sweep rheometric measurements between about 0.1 and about 600 rad/sec at 0.2 Pa and 1 Pa using a cone and plate viscometer method with a 60 mm 2° acrylic cone and plate at 20° C.

17. The gel composition of claim 16 wherein tan(delta) of the gel composition is from about 0.05 to about 1, from about 0.05 to about 0.9, from about 0.05 to about 0.8, from about 0.05 to about 0.7, from about 0.05 to about 0.6, from about 0.05 to about 0.5, from about 0.05 to about 0.4, from about 0.05 to about 0.3, from about 0.05 to about 0.2, or from about 0.05 to about 0.1.

18. The gel composition of any one of claims 1 to 4 wherein the stationary viscosity of the gel composition is from about 500 to about 150,000, from about 1,000 to about 100,000, from about 1,000 to about 50,000, or from about 1,000 to about 25,000 mPa second as measured according to a cone and plate viscometer method using a 60 mm 2° acrylic cone and plate at 20° C. with an oscillating frequency of 100 rad/s.

19. The gel composition of any one of claims 1 to 4 wherein the water content is from about from about 75 to about 92 wt % water, from about 80 to about 90 wt % water, from about 82 to about 90 wt % water, from about 84 to about 90 wt % water, from about 85 to about 90 wt % water, or from about 85 to about 88 wt % water.

20. The gel composition of any one of claims 1 to 4 wherein the water-soluble agrochemical salt component content is from about 4 to about 20 wt %, from about 5 to about 20 wt %, from about 5.5 to about 20 wt %, from about 6 to about 20 wt %, from about 6 to about 15 wt %, from about 6.5 to about 15 wt %, from about 7 to about 15 wt %, from about 6 to about 12 wt %, from about 6.5 to about 12 wt %, from about 7 to about 12 wt %, or from about 6 to about 10 wt % on an acid equivalent basis.

21. The gel composition of any one of claims 1 to 4 wherein the polymeric gel forming agent content is from about 1 to about 5 percent by weight, from about 1 to about 4 percent by weight, from about 1 to about 3 percent by weight, from about 2 to about 5 percent by weight, from about 2 to about 4 percent by weight, or from about 2 to about 3 percent by weight.

22. The gel composition of any one of claims 1 to 4 wherein the water-soluble agrochemical salt component comprises an agrochemical selected from the group consisting of herbicides, plant growth regulators, acaricides, insecticides, virucides, algicides, bactericides, fungicides, nematicides, herbicide safeners, plant activators or synergists, and combinations thereof.

23. The gel composition of claim 22 wherein the water-soluble agrochemical salt component comprises a water-soluble herbicide salt selected from the group consisting of 2,4-D, 2,4-DB, aminopyralid, amitrole, asulam, azimsulfuron, beflubutamide, benazolin, bentazon, bispyribac-sodium, bromacil, carbetamide, carfentrazone-ethyl, chlorimuron-ethyl, chlorsulfuron, cinosulfuron, clopyralid, dicamba, dichlorprop, diclofop, diclopyr, difenzoquat, dimethenamid, dimethipin, diquat, DSMA, endothall, ethoxysulfuron, floramsulfuron, florasulam, flucarbazone-sodium, flumetsulam, fluroxypyr, fosamine, glyphosate, glufosinate, glufosinate-P, halosulfuron-methyl, hexazinone, imazamethabenz-m, imazamox, imazapic, imazapyr, imazaquin, imazethapyr, iodosulfuron, MCPA, MCPB, mecoprop, mecoprop-P, MSMA, naptalam, nicosulfuron, paraquat, water-soluble salts of pelargonic acid, penoxsulam, picloram, primisulfuron-methyl, propoxycarbazone-sodium, prosulfuron, pyrithiobac-sodium, sethoxydim, sulfentrazone, sulfosulfuron, tebuthiuron, tepraloxydim, thifensulfuron-methyl, tralkoxydim, triasulfuron, tribenuron-methyl, triclopyr, trifloxysulfuron, triflusulfuron-methyl, and stereoisomers thereof.

24. The gel composition of any one of claims 1 to 4 wherein the water-soluble agrochemical salt comprises a salt of glyphosate.

25. The gel composition of claim 24 wherein the water-soluble agrochemical salt component comprises a glyphosate salt selected from the group consisting of an alkali metal salt, an amine salt, an ammonium salt, an alkylammonium salt, an alkanolammonium salt, a di-ammonium salt, an alkylamine salt, an alkanolamine salt, an alkylsulfonium salt, a sulfoxonium salt and mixtures thereof.

26. The gel composition of claim 25 wherein the water-soluble agrochemical salt component comprises a glyphosate salt selected from the group consisting of the potassium, isopropylamine, ammonium, di-ammonium, sodium, monoethanolamine, monoethanolammonium, trimethylsulfonium salt and mixture thereof.

27. The gel composition of claim 26 wherein the water-soluble agrochemical salt component comprises the potassium salt of glyphosate.

28. The gel composition of claim 26 wherein the water-soluble agrochemical salt component comprises the isopropylamine salt of glyphosate.

29. The gel composition of claim 26 wherein the water-soluble agrochemical salt component comprises the monoethanolamine salt of glyphosate.

30. The gel composition of any one of claims 1 to 4 further comprising a preservative.

31. The gel composition of any one of claims 1 to 4 further comprising a surfactant component comprising at least one surfactant.

32. The gel composition of claim 31 wherein the surfactant component comprises at least one surfactant selected from the group consisting of akoxylated tertiary etheramine, alkoxylated quaternary etheramine, alkoxylated tertiary amine oxide, alkoxylated tertiary amine, alkoxylated quaternary amine, alkoxylated etheramine oxide, polyamine, sulfate derivative, sulfonate derivative, phosphate ester of alkoxylated alcohol, alkyl polysaccharide, alkoxylated alcohol, amidoalkylamine, and combinations thereof.

33. The gel composition of any one of claims 1 to 4 further comprising at least one water-insoluble agrochemical dispersed therein.

34. The gel composition of any one of claims 1 to 4 wherein the water-soluble agrochemical salt component comprises pelargonic acid or an agronomically acceptable salt thereof.

35. The gel composition of any one of claims 1 to 4 wherein the gel composition is a pseudoplastic gel.

36. The gel composition of any one of claims 1 to 4 wherein the gel composition is a single phase composition.

37. A method for confined application of water-soluble agrochemical salt to plants, the method comprising applying the agrochemical gel composition of any one of claims 1 to 4 to the plants.

38. The method of claim 37 wherein the agrochemical gel composition is applied to the foliage of the plants with a hand-held sprayer, a roller or a brush.

39. The method of claim 37 wherein the agrochemical gel composition is applied to the plants by cut stump application, cut and swab application, stem scraping application, or hack and squirt application.
